(19) United States
(12) Patent Application Publication
(10) Pub. No.: US 2026/0313255 A1
(43) Pub. Date: Oct. 8, 2026

(54) GLOBALLY SYNCHRONOUS LOCALLY ASYNCHRONOUS EVENT BASED IMAGE SENSOR READOUT

(71) Applicants: Hussein Ali, Foothill Ranch, CA (US); Rajkumar Chinnakonda Kubendran, Pittsburgh, PA (US)

(72) Inventors: Hussein Ali, Foothill Ranch, CA (US); Rajkumar Chinnakonda Kubendran, Pittsburgh, PA (US)

(21) Appl. No.: 19/440,575

(22) Filed: Jan. 5, 2026

Related U.S. Application Data
(60) Provisional application No. 63/782,748, filed on Apr. 3, 2025.

(51) Int. Cl. H04N 25/47; H04N 25/767; H04N 25/78

(52) U.S. Cl. CPC H04N 25/47; H04N 25/767; H04N 25/78

(57) ABSTRACT

Event-Based pixels operate continuously and output data when there is a change in scene brightness, requiring more information for identification in the readout process compared to Frame-Based integration pixels. The proposed readout system uses asynchronous pixels to detect events and a synchronous scan signal to check pixel status, significantly simplifying image processing and reducing power consumption. Additionally, a global sampling technique with differential operation by the sense amplifier and added reference column lines is used to reduce noise coupling and increase operational speed.

### RELATED APPLICATIONS

This application claims the priority of U.S. Provisional Application No. 63/782,748, entitled “GLOBALLY SYNCHRONOUS LOCALLY ASYNCHRONOUS EVENT BASED IMAGE SENSOR READOUT” filed on Apr. 3, 2025, the disclosure of which is hereby incorporated by reference in its entirety.

### BACKGROUND OF THE INVENTION

Event-Based pixels operate continuously in time, and output data only if there is a change in the scene brightness. This autonomous operation needs more information from each pixel, for identification in the readout process. This information is typically not needed in the Frame-Based integration pixels, as the fully synchronous operation can easily identify each pixel. As shown in FIG. 1, the EB pixel has (x,y,t), where (x,y) represents the pixel location, and (t) is the equivalent time taken to register the corresponding pixel change. Each of (x,y,t) is encoded into number of bits determined by the array size, and the resolution needed to represent the timing information. This makes a larger pixel array, which corresponds to higher spatial resolution, harder and slower in readout, in addition to a larger pixel size to accommodate the larger number of bits needed for the (x,y) information.

### SUMMARY OF THE INVENTION

Event-Based image sensors use fully autonomous pixels to reproduce human vision system, in order to achieve lower power, shorter latency, and minimize the output data from the sensor, relative to traditional Frame-Based imagers. However, due to a discrepancy between the massive parallelism of human processing and the relatively limited parallelism achievable in integrated circuits technology, the state-of-the-art EB sensors resort to complex processing to decode the pixel information, and this eventually transfers the data deluge problem from the sensing side, as in the high-speed FB sensors, to the processing side.

An image sensor readout system is proposed, where the pixels operate asynchronously to detect events, and a synchronous scan signal checks each pixel status, and output the pixel information if there is a change. This global synchronous check minimizes the pixel information processing dramatically, while the asynchronous pixel operation preserves the autonomous function of the EB sensors. This will significantly simplify the image processing, shorten the overall system latency, reduce power consumption, and achieve higher speed in large pixel arrays due to the modular design of the synchronous system. In addition, an analog readout method is proposed, to be done in the data transfer to the periphery, e.g. on the column lines, which moves the high-speed digital clock used in digital readout counterpart, from the pixel array area to the periphery, which minimizes noise coupling and achieves better sensitivity in large pixel arrays, e.g. higher resolution cameras, and reduces area by eliminating the digital pipelining block, e.g. shift register, from each pixel.

Two readout schemes are proposed, which are applied to EB pixels, Dynamic Vision Sensor pixels, and digital pixels. The first scheme is based on Parallel-In-Serial-Out (“PISO”) registers and is suitable for large pixel array. The second scheme is based on Sense-Amplifier readout and is suitable for low noise operation. Both of these schemes simplify the sensor readout, enables faster output data rate, and makes it easier to interface with the vision system.

The architecture of the PISO readout may be summarized as a pipelining of digital bits, which are the output of the EB pixel, through shift registers, and the readout is done through a Parallel-In-Serial-Out through the column lines to the periphery outside of the pixel array. A clock signal, clk_row, is used to synchronize the operation. A global signal, gs, can be used to perform global sampling and load the events data into the shift registers. A PISO readout cell can be used, per pixel, to pipeline the read of the pixel data. A storage cell can be used inside the PISO to enable the serial read of multiple bits of pixels with multi-bit quantization. These pixels can be event-based, DVS, or integration-based APS.

The architecture for the SA readout may be summarized as a globally synchronous locally asynchronous digital readout method in Event-Based image sensors, which can be generalized to image sensors with pixels that output digital data. A row select signal, e.g. rs_i, is used to check the status of each pixel. If the pixel registers event, it transfers the pixel data to the column lines, otherwise, if no event is registered, it forces high impedance between the pixel data lines and the column lines. A precharge circuit, used to set initial conditions on the column lines between each pixel scan, set a default read of no events by the sense amplifiers.

An additional reference column line per each signal line is added (e.g. BL0n and BL1n in FIG. 5), to perform differential operation by the sense amplifier, and eliminates common noise coupling to the signal lines in the array, and possibly using twisted bitlines in the layout, or similar coupling reduction concepts. The differential operation of sense amplifier, and the added reference column lines, both are used to significantly relax the settling requirements, which translates into higher operational speed. A clock signal, synchronized with the row select signal, used to pipeline each pixel data, through a shift register or similar block in functionality, to the periphery for further processing

All other variants of the proposed system and methods, including simplifications of circuits and logic (e.g. FIG. 12 is derived from FIG. 7, and FIG. 9 is derived from FIG. 5), are all derived from the same basic principle and part of the disclosed invention.

Several important achievements are thus obtained with the proposed method. First, a dramatic reduction in the identification data needed from each pixel. Second, the proposed method eliminates the complex processing of the output data stream. Third, higher resolution event based cameras are possible, since larger pixel array processing is possible at high speed, due to the modularity of the global synchronous approach in checking the status of each pixel. Fourth, the system consumes less power since data activity is much lower. Fifth, with the PISO readout scheme, higher speed in very large pixel array can be achieved, and storage with serial read can be added for multi-bit quantization inside the pixel, which can be applied in the DVS pixel and in conventional Active Pixel Sensor pixel. Sixth, smaller coupling and better sensitivity due to the removal of the high-speed clock from the pixel array to the periphery. This is also reducing dynamic power consumption.

A system for an event-based sensor readout may include a pixel die including a plurality of pixels receiving an analog signal. The event-based sensor may further include a readout integrated circuit including a plurality of asynchronous dynamic vision sensors in operable communication with the plurality of pixels over a plurality of associated bitlines. In one embodiment, the plurality of asynchronous dynamic vision sensors may generate a plurality of event flag signals and a plurality of event data signals. The system may further include a column bus having a plurality of shift registers receiving the generated plurality of event flag and event data signals from the asynchronous dynamic vision sensors. In some implementations, the plurality shift registers may serialize the generated plurality of event flag signals and event data signals and transmit the serialized plurality of event flag and event data signals to a data output to a plurality of column lines.

The plurality of pixels may be implemented as three transistor pixels and each of the plurality of the three transistor pixels may further include a photodiode and a bitline output node. In one embodiment, the plurality of event flag signals are representative of a detected change in pixel brightness and the plurality of event data signals are representative of a detected change in direction. According to one embodiment, the plurality of column lines include a first column line and a second column line and the first column line receives the plurality of event flag signals and the second column line receives the plurality of event data signals. The event-based sensor may be in communication with a plurality of periphery circuits receiving the serialized plurality of event flag signals and event data signals. The plurality of shift registers noted above may perform a parallel in serial out operation with the generated plurality of event flag signals and event data signals from the asynchronous dynamic vision sensors.

A system for an event-based sensor readout may include a pixel die including a plurality of pixels receiving an analog signal. The system may further include a readout integrated circuit including a plurality of asynchronous dynamic vision sensors in operable communication with the plurality of pixels over a plurality of associated bitlines. In one embodiment, the plurality of asynchronous dynamic vision sensors may generate a plurality of event flag signals and event data signals. The event-based sensor may include a column bus receiving the generated plurality of event flag signals and event data signals and a plurality of column lines transmitting the generated plurality of event flag signals and event data signals to a data output. The system may further include an electrical clamp line pre-charging the plurality of column lines to a predefined voltage level. According to one embodiment, the event based sensor may include a global sampling block sampling the generated plurality of event flag signals and event data signals from the asynchronous dynamic vision sensors. The system may further include a row select logic block generating a switch enable signal utilized to control a plurality of switches.

In some implementations, a system for an event-based sensor readout may include a pixel die including a plurality of pixels receiving an analog signal. The system may also include a readout integrated circuit including a plurality of asynchronous dynamic vision sensors in operable communication with the plurality of pixels over a plurality of associated bitlines. In one embodiment, the plurality of asynchronous dynamic vision sensors may generate a plurality of event flag signals and event data signals. The system may further include a column bus receiving the generated event flag and event data signals from the asynchronous dynamic vision sensors and a plurality of single-ended column bitlines transmitting the generated plurality of event flag signals and event data signals to a data output.

The event based sensor may further include an electrical clamp line applying a clamp voltage at a plurality of input nodes associated with a plurality of sense amplifiers. In one embodiment, the system further includes a global sampling block sampling the generated plurality of event flag signals and event data signals from the asynchronous dynamic vision sensors. The event-based sensor may utilize a row select logic block generating a switch enable signal utilized to control a plurality of switches.

A method for performing readout of an event-based sensor includes receiving an analog signal at a pixel die including a plurality of pixels and connecting the pixel die with a readout integrated circuit. According to one embodiment, the readout integrated circuit is placed in operable communication with the plurality of pixels over a plurality of associated bitlines. The plurality of asynchronous dynamic vision sensors may generate a plurality of event flag signals and event data signals. The method may further receive the generated plurality of event flag and event data signals at a column bus having a plurality of shift registers. According to one embodiment, the readout method may have the plurality shift registers serialize the generated plurality of event flag and event data signals and transmit, via a plurality of column lines, the serialized plurality of event flag signals and event data signals to a data output.

The readout method may further include representing a detected change in brightness within the generated plurality of event flag signals. According to one embodiment, the method may represent a detected change in direction within the generated plurality of event data signals. The readout method may also include performing a parallel in serial out operation with the generated plurality of event flag signals and event data signals from the asynchronous dynamic vision sensors. In one embodiment, the event-based sensor may receive the serialized plurality of event flag signals and event data signals at a plurality of periphery circuits.

In some implementations, the method may include conducting a row status check at the beginning of a frame and conducting an event registered check based on the generated plurality of event flag signals and event data signals from the asynchronous dynamic vision sensors. The event-based sensor may also read the generated plurality of event flag signals and event data signals onto the plurality of column lines when the event registered check is positive. In one embodiment, the method may include storing the generated plurality of event flag signals and event data signals onto the plurality of periphery circuits.

### BRIEF DESCRIPTION OF THE FIGURES

FIG. 1 illustrates a block diagram of an autonomous event based pixel array.

FIG. 2a illustrates a block diagram of an event based pixel array.

FIG. 2b illustrates a circuit diagram of a dynamic vision sensor pixel.

FIG. 3 illustrates a digital readout of data to the periphery using shift register PISO.

FIG. 4 illustrates one embodiment of a PISO cell.

FIG. 5a illustrates a block diagram of a readout method, shown for one column in an event based pixel array.

FIG. 5b illustrates differential bitline configurations to reduce crosstalk in an array of pixels.

FIG. 6 illustrates a block diagram of a global sampling technique.

FIG. 7 illustrates a block diagram of row select logic.

FIG. 8 illustrates a timing diagram of a readout method.

FIG. 9 illustrates a block diagram of a readout method, shown for one column in an event based pixel array.

FIG. 10 illustrates a block diagram of an event based pixel array.

FIG. 11 illustrates a block diagram of a global sampling technique.

FIG. 12 illustrates a block diagram of row select logic.

FIG. 13 illustrates a timing diagram of a readout method.

FIG. 14 illustrates a flow chart of the read sequence.

FIG. 15 illustrates a schematic diagram of a system for performing readout of event-based sensor.

### DETAILED DESCRIPTION OF THE INVENTION

The present invention is described in the following examples, which are set forth to aid in the understanding of the invention, and should not be construed to limit in any way the scope of the invention as defined in the claims which follow thereafter. The locally asynchronous globally synchronous digital readout invention of the EB sensor presents a method to dramatically reduce the identification data needed from each pixel, to simplify the image signal processing, and reduce the output data from the sensor.

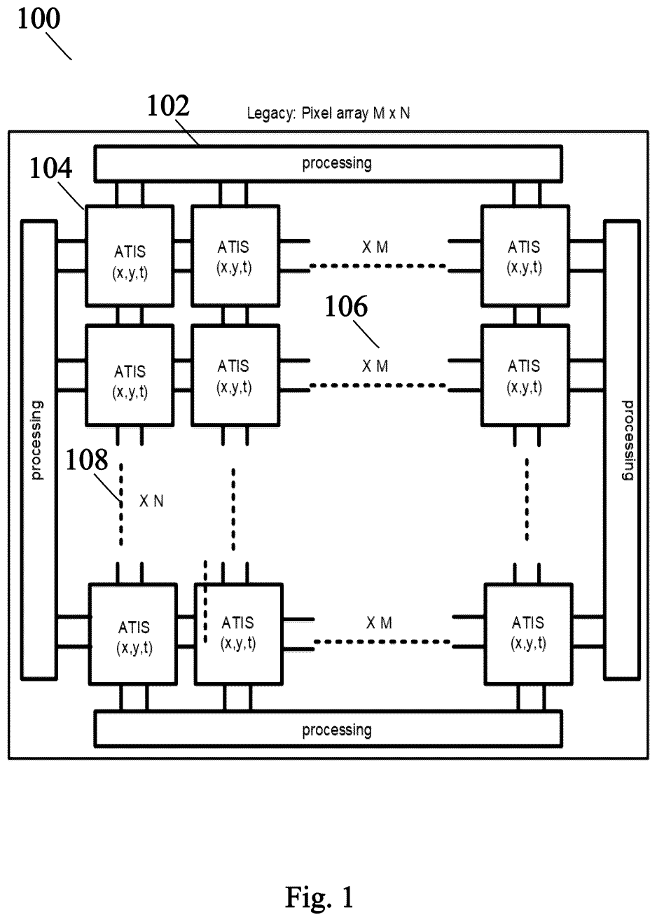

FIG. 1 illustrates a block diagram 100 of an autonomous event-based pixel array. The legacy pixel array illustrated in FIG. 1 is an asynchronous time-based image sensor (“ATIS”). FIG. 1 shows a processing block 102 above the top row of pixel array 100. Other processing blocks may be observed in FIG. 1 below the bottom row and to left and right of the proximal column and distal column of pixels, respectively. FIG. 1 shows a plurality of rows XM 106 and a plurality of columns XN 108. In the legacy system, the autonomous operation needs more information from each pixel, for identification in the readout process. This information is typically not needed in the Frame-Based integration-based pixels, as the fully synchronous operation can easily identify each pixel. As shown in FIG. 1, the EB pixel has (x,y,t), where (x,y) represents the pixel location, and (t) is the equivalent time taken to register the corresponding pixel change. Each of (x,y,t) is encoded into number of bits determined by the array size, and the resolution needed to represent the timing information. This makes a larger pixel array, which corresponds to higher spatial resolution, harder and slower in readout, in addition to a larger pixel size to accommodate the larger number of bits needed for the (x,y) information.

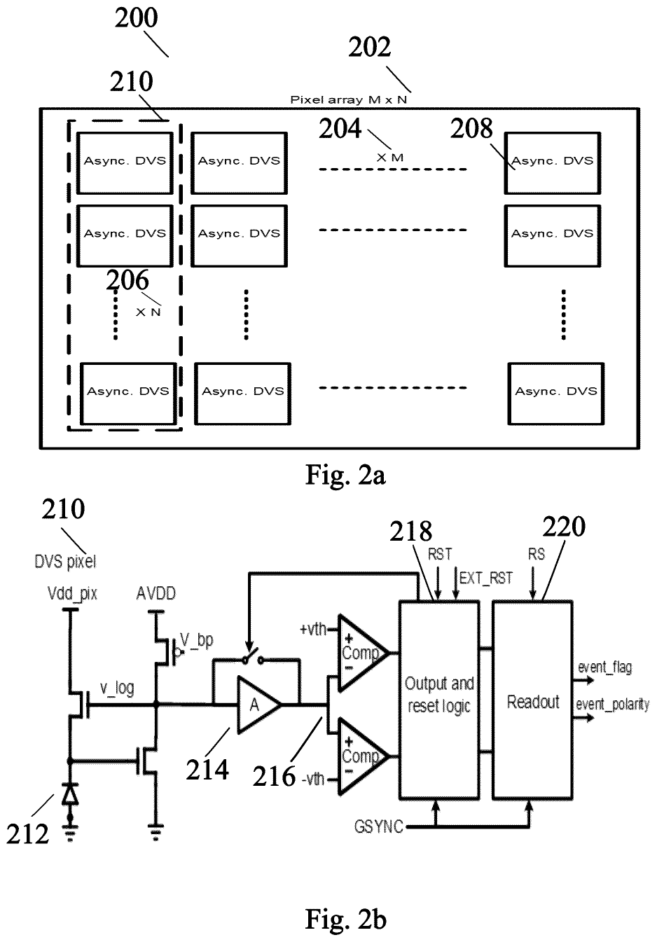

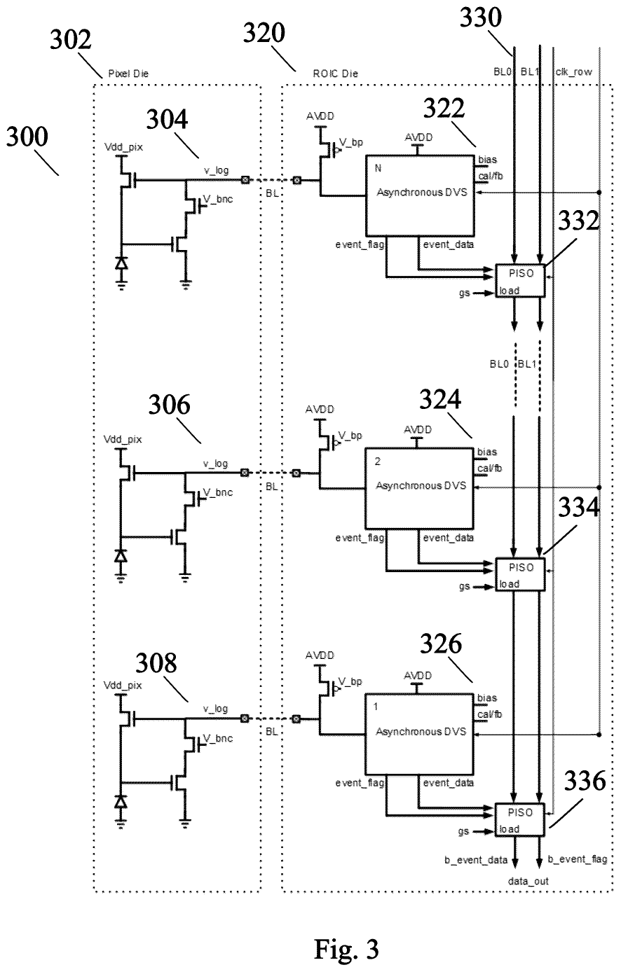

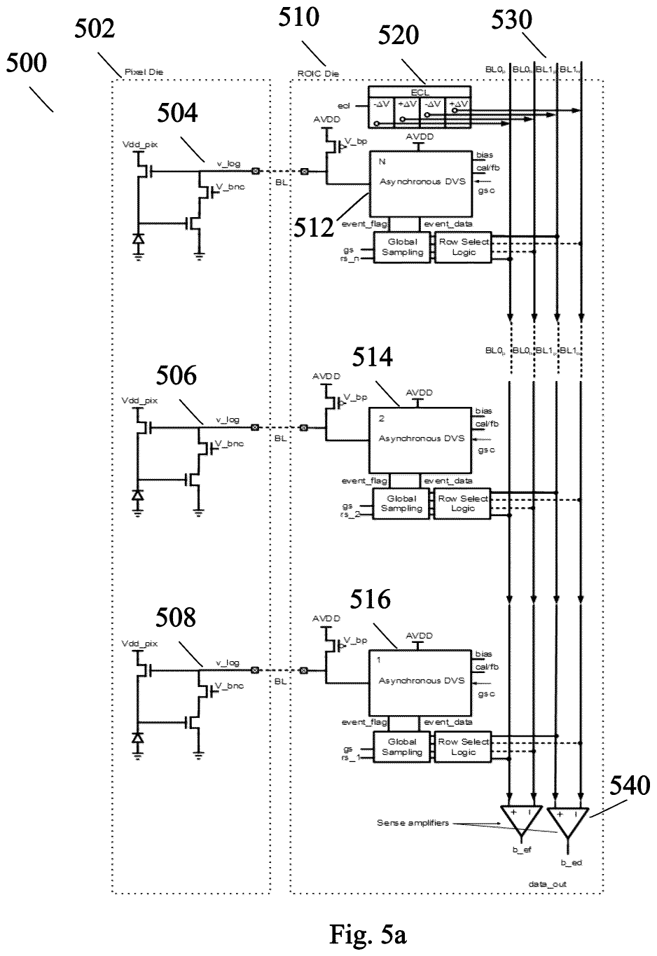

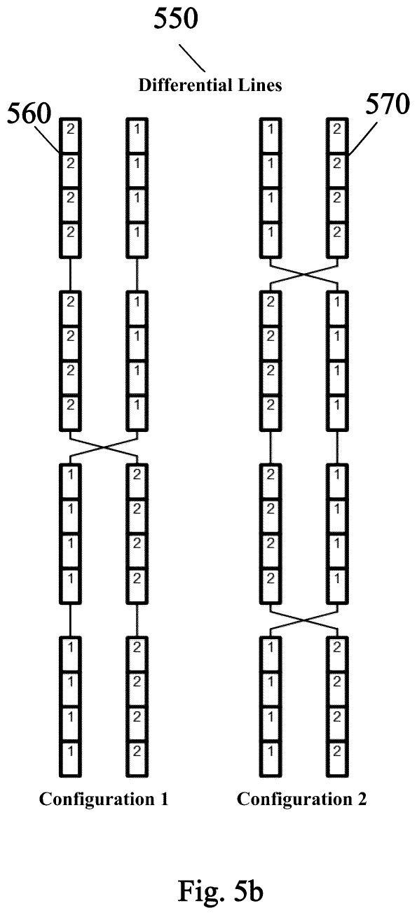

FIG. 2a illustrates the simplified block diagram of the pixel array, where a column is put in FIG. 3 and FIG. 5, to illustrate two schemes for the readout operation. FIG. 2a shows a pixel array M×N 202. The pixel array includes Asynchronous Dynamic Vision sensor 208 across columns XN 206, and rows XM 204. A Dynamic Vision Sensor (DVS) is an event-based image sensor that detects changes in brightness at each pixel rather than capturing full frames at fixed time intervals like conventional CMOS or CCD sensors. Dynamic Vision Sensors (DVS) may be asynchronous leading to enhanced and improved temporal resolution (≈1 μs) and high throughput (>1 Giga-events per second) but sometimes challenging to scale for higher resolutions (>1 MegaPixels) due to the complex pixel design and higher static power consumption. Another benefit is high-speed, low-power, and low-latency vision processing, making DVS ideal for applications requiring real-time motion detection. The process of a DVS includes: 1) photodiode sensing (each pixel has a photodiode (PD) that continuously monitors light intensity); 2) logarithmic encoding (light intensity is encoded in a logarithmic scale to allow a wide dynamic range); 3) threshold-based change detection (when the brightness at a pixel changes beyond a set threshold (ΔI/I), an event is triggered); 4) event output (the changed pixel coordinates (X, Y) and the change type (increase or decrease in brightness) are sent).

FIG. 2b illustrates a circuit diagram of an asynchronous dynamic vision sensor pixel. The circuit 210 includes a photodiode 212, a common source amplifier 214, a pair of comparators 216 and a digital output control and reset logic block 218, and a readout block 220. As noted above, the pixel illustrated in FIG. 2b is an asynchronous DVS pixel. The DVS pixel responds to changes in the scene, and outputs only two bits for event status and event polarity. The pixel front-end has the PhotoDiode “PD”, which is configured to generate a logarithmic voltage, v_log, proportional to the change in the PD current, which corresponds to a change in the scene illumination level. This voltage is then amplified by a gain stage, “A”, and the output is compared to two thresholds, +vth and −vth, to determine the change polarity. The DVS pixel operation is locally autonomous, continuously monitoring the PD current change, and take the event decision based on the corresponding logarithmic voltage, v_log, when compared to the preset threshold voltages. The global sampling signal, GSYNC ‘gs’, stores the event status at a certain instance of time, and the RS ‘rs’ signal check the corresponding two bits, event_flag and event_polarity, for event status and event polarity, respectively. The RS ‘rs’ readout these bits to the periphery. EXT_RST signal forces reset in the pixel, if the pixel didn't register an event for long time, determined by the amount of leakage, and/or the low frequency noise. The 2-bit output of the DVS pixel is read to the periphery, along with other outputs from other DVS pixels in the array, in a process called digital readout. The completion of readout of all the pixels in the array defines the frame readout. The frame rate defines the throughput, which is how fast we can read the frame; how many frames could be read in one second.

FIG. 3 illustrates one embodiment of a Parallel In Serial Out Operation, PISO readout scheme 300. To transfer the data out from pixel array to the periphery circuits, a shift register is used per pixel, to perform Parallel In Serial Out Operation, (“PISO”), as shown in FIG. 3 to digitally pipeline the data through a shared route, e.g. column line, to the external circuits. This potentially adds coupling from high-speed clock inside the pixel array. FIG. 3 includes a pixel die 302, a Readout Integrated Circuit (“ROIC”) die 320 and column bus 330. The pixel die shows one column of pixels, which is part of an array of columns and rows. The ROIC die shows one column of asynchronous dynamic vision sensor pixels, which is part of an array of columns and rows, as well as the column bus 330 that corresponds to one column in the array. The column bus depicted shows a plurality of column lines and a plurality of shift registers 332, 334 and 336 that repeats along the column so that we have one PISO shift register per pixel. Each pixel in the pixel die may include a photodiode, a plurality of transistors and a bitline (BL) transmitting the output from the pixels 304-308 through a bitline (BL) to the plurality of Asynchronous DVS sensors 322-326. The asynchronous DVS sensors detect temporal contrast changes in pixel output. As illustrated, the asynchronous DVS sensors include a plurality of inputs and outputs, a PISO register which transmits event data to the column bus 330. The column bus 330 produces the output stream of serialized event data. This readout configuration, where all pixels' outputs are stored at once, then read sequentially to the periphery, can perform global sampling operation of the DVS pixels, and maximizes the throughput by moving the data to the periphery with minimum timing overhead, using simple and modular architecture.

To transfer the data out from pixel array to the periphery circuits, a shift register is used per pixel, to perform PISO, as shown in FIG. 3, to digitally pipeline the data through a shared route, e.g. column line, to the external circuits. Each Asynchronous Dynamic Vision Sensor pixel, (DVS), has two outputs, event_flag represents a detected change in the pixel brightness, and event_data encodes the direction of change. In one embodiment, the change in pixel brightness may be understood a difference in pixel value or photodiode current between frames. The direction of change may be understood as polarity or whether brightness is increasing or decreasing. In some implementations, the direction of changed may be a Boolean value set to True or On when brightness at the pixel has increased and False or Off when brightness at the pixel has decreased. Both outputs (event_flag and event_data) are read on the column lines BL1 and BL0, respectively. The column lines, BL0 and BL1, have shift registers, which pipeline the DVS pixels' data to the periphery for further processing. This pipelining is done through a Parallel-In-Serial-Out digital shifter registers, PISO, where a clock signal, clk_row, is used to synchronize the operation. A global signal, gs, can be used to perform global sampling and load the events data into the shift registers.

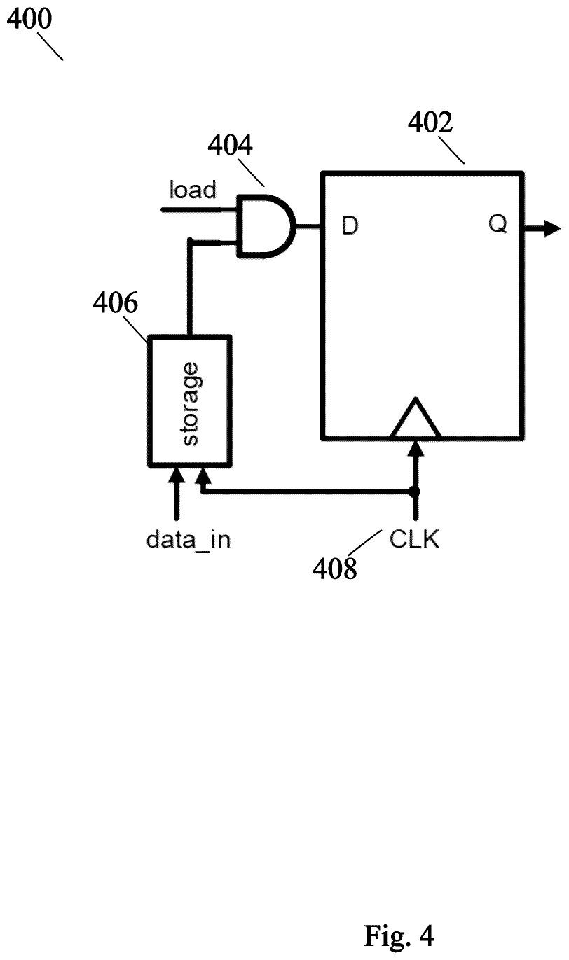

FIG. 4 illustrates a potential unit cell for the PISO 400. The unit cell 400 includes a D Flip-Flop 402, and AND gate 404, a storage cell 406 and a clock input (CLK) 408. In one embodiment, the D Flip-Flop is used with logic gates to load the events data, data_in. This can be generalized to include multi-bit quantization inside the pixel, where storage is needed, and bits are loaded and read in series from the storage cell. Quantization may include mapping a range of v_log analog signal values received from the pixel die to discrete digital levels. When generalized to include multi-bit quantization, the unit cell 400 can represent each analog input may be represented by multiple bits—for example, 2 bits, 4 bits, 8 bits, etc. The number of levels which can be represented in this manner is 2ⁿ levels (for n bits). For example, multi-bit quantization with 8 bits can represent 2⁸ levels or 256 levels. The PISO readout method is efficient in large pixel array; >3 Mega Pixels, in which the long column lines will limit the readout speed. It is also susceptible to coupling from high-speed clock running inside the array. The readout using sense amplifiers is a low noise method and is shown in FIG. 5a.

FIG. 5a illustrates an alternative readout of an array of DVS pixels 500 in the pixel die. This is simplification from the PISO digital readout, when the column lines are not very long; <10 mm, and avoids the addition of the registers, which minimizes the area. This readout avoids the high speed clock in the PISO digital readout, which reduces crosstalk. Depicted in FIG. 5a is a pixel die 502 and a ROIC die 510. The pixel die includes a plurality of pixels 504, 506 and 508, showing one column of pixels, which is part of an array of columns and rows. The ROIC die includes a column of asynchronous DVS pixels 512, 514, 516, showing one column of DVS pixels, which is part of an array of columns and rows, and Electrical Clamp Line (ECL) block 520, a column bus 530 and a pair of sense amplifiers 540. Within the ROIC die is a column of Asynchronous Dynamic Vision Sensor pixels, DVS, with the corresponding bitlines, BL0p,n and BL1p,n, precharge circuit, ECL, Global Sampling (“GS”), and Row Select Logic (“RSL”). Each DVS pixel has two outputs, event_flag represents a detected change in the pixel brightness, and event_data encodes the direction of change. These outputs are sampled inside each corresponding GS block. The ECL block pre-charges the column lines in the column bus to a predefined voltage levels. These voltage levels, ±ΔV, are chosen such that the power consumption and the speed of the sense amplifiers are optimized; less power and higher speed. The sense amplifiers read the pixels' outputs and buffer the data to the periphery circuits. The additional bitlines represent the differential form of the pixel outputs, to minimize crosstalk in large pixel arrays; >3 MP. FIG. 5b shows differential bitlines configurations in layout, to reduce crosstalk in large array of pixels, where differential line BL0, which consists of BL0p and BL0n, corresponds to Configuration line 1 and Configuration line 2 in the figure. The twisted differential bitline configurations shown in FIG. 5 include a first configuration illustrating a single mid-column twist and a second configuration illustrating a multiple twist configuration.

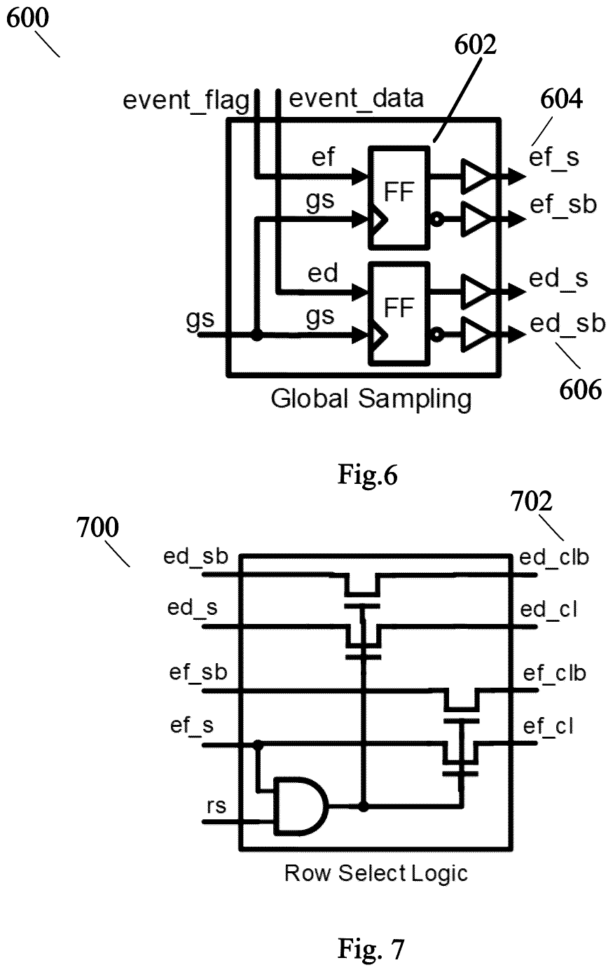

FIG. 6 illustrates the Global Sampling, GS block. Global sampling generally refers to a mode where a pixel array, or a given subset of it, is sampled at a defined time to capture the state of all pixels (or the subset) at once. The global sampling signal, gs, triggers the pair of Flip-Flops 602 to store the event_flag and the event_data, and generate their inversion, ef_s, ed_s, ef_sb, and ed_sb, respectively. FIG. 6 further illustrates two outputs 604, 606 associated with the pair of Flip-Flops. Output 604 shows ef_s_ (event flag signal) and ef_sb (inversion signal of ef_s). Output 606 shows ed_s (event data signal) and ed_sb (inversion signal of ed_s). This GS block may be implemented as part of the DVS pixel. According to one embodiment, the asynchronous DVS detects brightness asynchronously while the global sampling block periodically captures image frames. This design advantageously combines the benefits of DVS (high temporal resolution and APS (full-scene reference frames providing context).

FIG. 7 illustrates the processing of the sampled outputs in the RSL 700. The RSL uses a row select signal, rs, and the sampled event_flag signal, ef_s, to generate a switch enable signal by an AND gate. This switch enable signal is then used to control the switches, such that whenever the rs_i and the ef_s are active high, the switches are short circuit, and the sampled data are on the column lines 702, such that ef_cl, ef_clb, ed_cl, and ed_clb are on the lines BL0p, BL0n, BL1p, and BL1n, respectively. If no event is registered, ef_s is not active, and so all the column lines are floating, which is the equivalent state of a high impedance. The ECL is using the ecl signal to precharge the column lines by ±ΔV between each row read. Each row read is determined by the row scanning signals, rs_i. This makes the sense amplifiers outputs are in the default state of zero, which is the no event case. The sense amplifiers default states are no event, until an event registered from any pixel is transferred through the column lines.

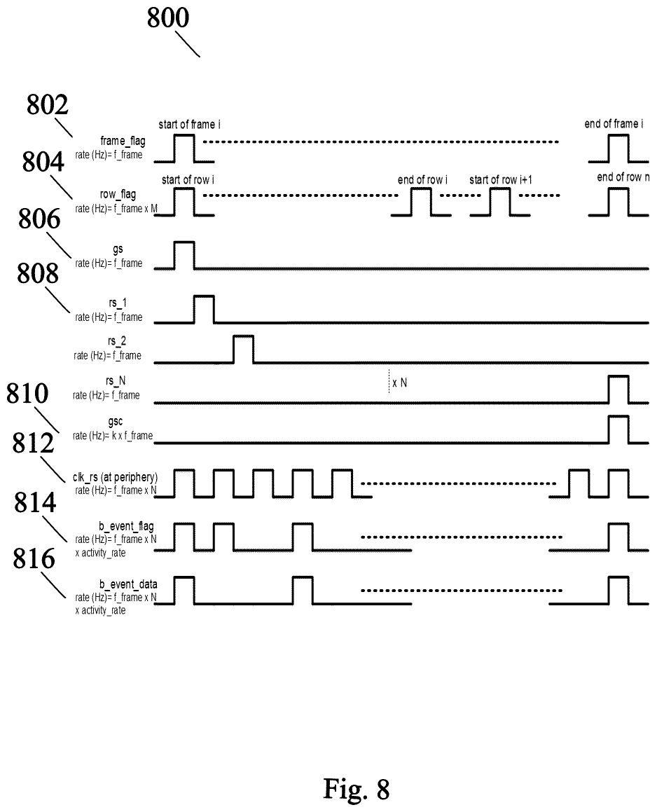

FIG. 8 illustrates the timing of the readout method. The frame_flag 802 defines the start and the end of scanning the whole pixel array, M×N. The row_flag 804 determines the start and the end of each row data. Both identify the location of each pixel in the output data stream, and they are synchronized with the row scan signal, rs_i 808, and the row clock, clk_rs. The clk_rs 812 is high speed signal, and it is put only in the periphery. The global scan complete signal, gsc, 810 resets only the pixels which register change, otherwise, pixels reporting no change are not reset. This preserves the autonomous function of each pixel. The DVS bits, b_ef 814 and b_ed 816, are active only when there is a change in the corresponding pixel. The column lines which hold the sampled inversion of the event_flag and event_data, BL0n and BL0p, are mainly to reduce coupling by techniques used by the memory cells access, for example through differential signaling and twisted bitlines.

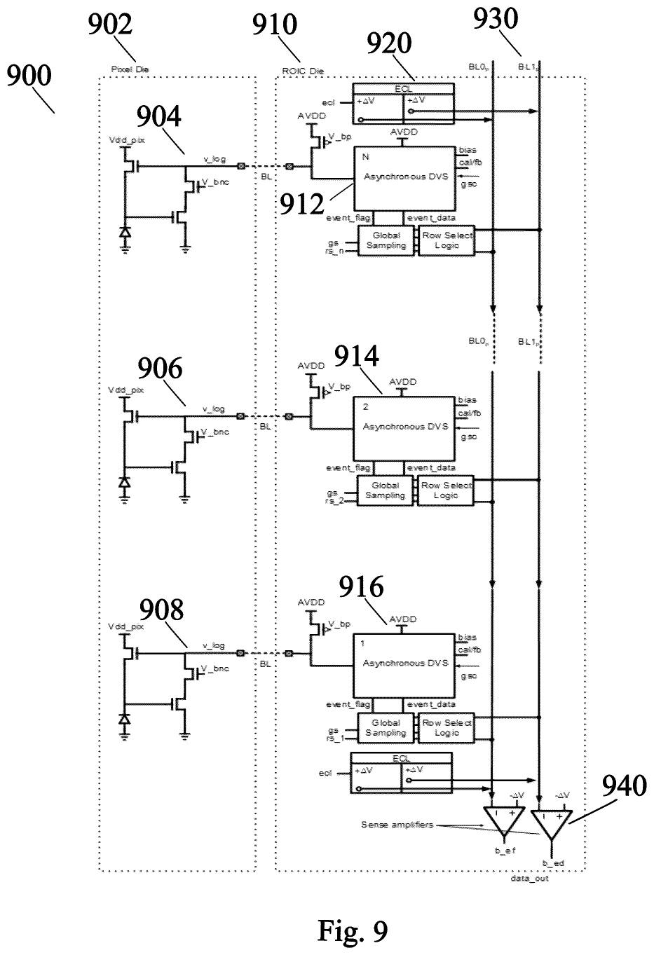

FIG. 9 illustrates a circuit diagram 900. Depicted in FIG. 9 is a pixel die 902 and a ROIC die 910. The pixel die includes a plurality of pixels 904, 906 and 908, which is part of an array of columns and rows. The ROIC die includes a column of asynchronous DVS pixels 912, 914, 916, showing one column of DVS pixels, which is part of an array of columns and rows, and Electrical Clamp Line (ECL) block 920, a column bus 930 and a pair of sense amplifiers 940. This readout is a simplified version of FIG. 5, by using single-ended bitlines instead of differential ones, so that the column bus has two lines instead of four. The clamp voltage, −ΔV, is applied at the periphery at the input of the sense amplifiers. This simplified readout can be used in the scenario in which the crosstalk coupling from the pixel array is not significant, which is typically the case in arrays of resolution <3 MP. In that case, the precharge circuit, ECL, needs only to provide +ΔV, while −ΔV is generated outside of the array, at the periphery. The choice of ΔV is such that it minimizes the power dissipated on the column lines, while it still makes the sense amplifier operation functional and fast. ΔV is programmable and can be optimized by changing the settings.

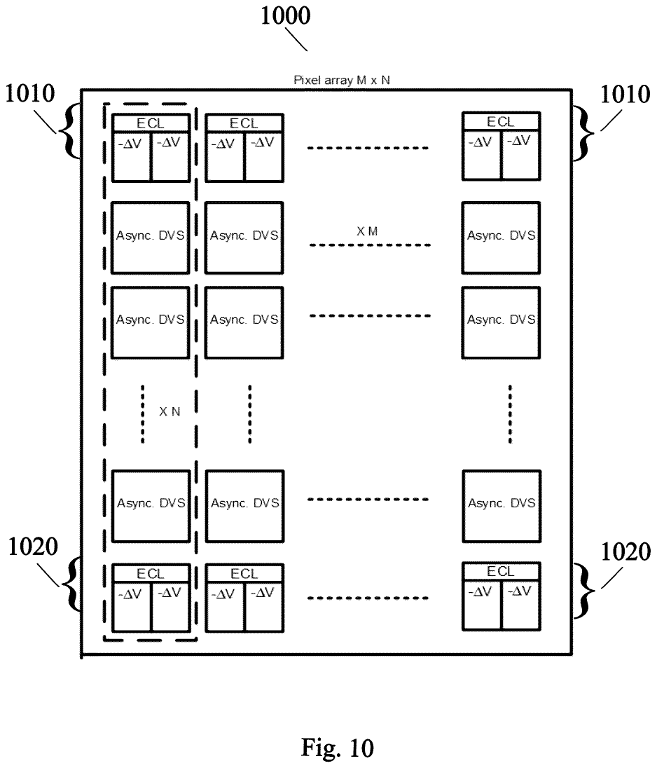

FIG. 10 illustrates one embodiment of a pixel array incorporating the precharge circuit as additional rows at the top and the bottom. The pixel array of FIG. 10 shows the top precharge circuit 1010 and the bottom precharge circuit 1020. The pixel array is size M×N. This configuration makes the clamp voltages, for all the pixels, more uniform across the array, which minimizes the readout errors, and reduces the image distortion.

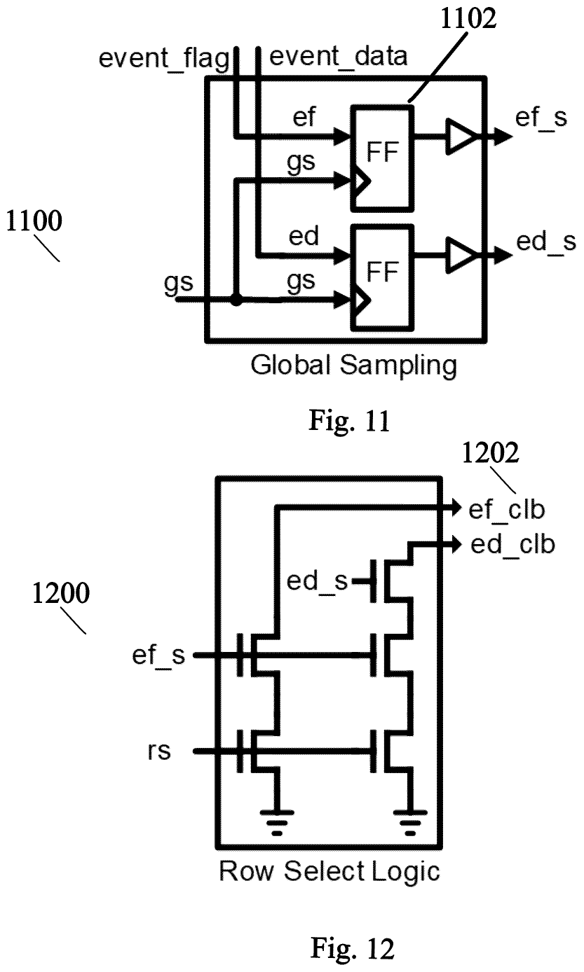

FIG. 11 illustrates a simplified version of the Global Select block, where (when compared to FIG. 6) the inversion signals are removed. Global sampling generally refers to a mode where a pixel array, or a given subset of it, is sampled at a defined time to capture the state of all pixels (or the subset) at once. The global sampling signal, gs, triggers the pair of Flip-Flops 1102 to store and transmit the event_flag signal and the event_data signal.

FIG. 12 illustrates a simplified version of the Row Select Logic block, RSL, where the same functionality is achieved as the one in FIG. 7, without the inverted signals. The RSL output 1202 includes two signals, the ef_clb (event flag column bitline) and the ed_clb (event_data column bitline). The two signals are ultimately transmitted to a pair of sense amplifiers.

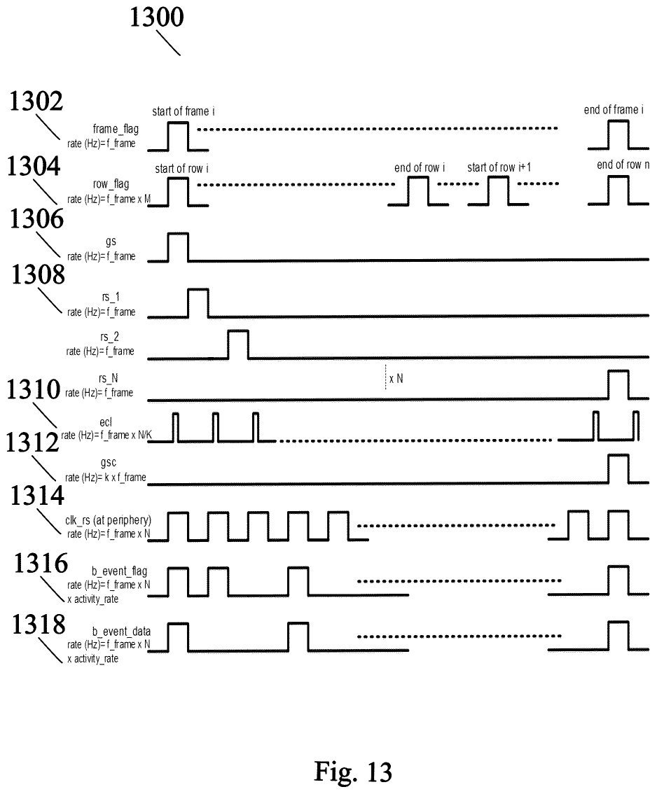

FIG. 13 illustrates one embodiment of a timing diagram The timing diagram 1300 shows a plurality of timing graphs. The plurality of timing graphs include a frame_flag timing graph 1302, a row flag timing graph 1304, a global sampling timing graph 1306, a plurality of row scan signal timing graphs 1308, an ecl timing graph 1310, a global scan complete signal (gsc) timing graph 1312, a row clock (clk_rs) (at periphery) timing graph 1314, a b_event_flag timing graph 1316 and a b_event_data timing graph 1318. The ecl signal frequency is the frame rate multiplied by the number of rows to be read by scanning, N. This precharging frequency may be scaled down by K, where K is programmable, and it is set to optimize the image quality.

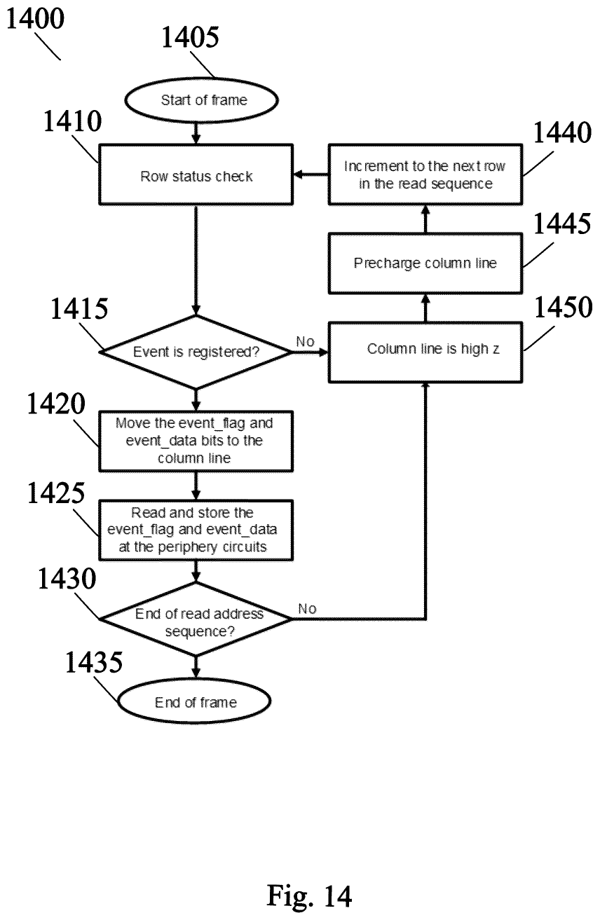

FIG. 14 illustrates the flow chart that summarizes the readout method. The flow chart 1400 illustrated in FIG. 14 begins with a start of frame 1405. The start of the frame is triggered by the frame_flag signal. The row status check 1410 is performed by the rs_i signal. A check is performed to determine if an event has registered 1415. If no event is registered, the column line is in a high impedance status 1450, and it is precharged 1445 to the default status of no event using the ecl signal, before incrementing to the next row in the read sequence 1440. If event is registered, the event_flag and event_data bits are read on the column lines 1420, the sense amplifier detects their status, and the periphery circuits store them 1425, and send them to the processing units. A check is performed to determine if the read address sequence is completed active 1430. If the read sequence is not completed, it moves the column lines to the high impedance status, and cycle is repeated, until the end of the read sequence 1435.

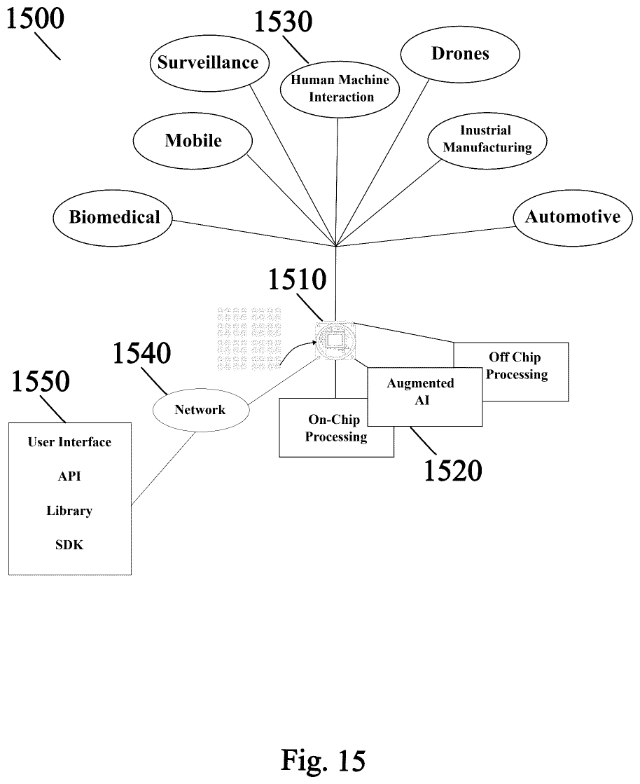

FIG. 15 illustrates a schematic diagram of a system for performing readout of event-based sensor. FIG. 15 illustrates a schematic diagram of a vision sensor system according to one embodiment. The vision sensor system 1500 depicted in FIG. 15 includes a sensor/array of sensors 1510, a suite of processing blocks 1520, including on-chip processing, augmented AI and off chip processing. The schematic further includes a network 1540 in communication with the sensor/array of sensors and a software stack 1550. The software 1550 may include a graphical user interface, an Application Programming Interface (API), a software library, and a software development kit (SDK). The software may include modules customized to operate in a set of environment specific applications 1530. In one example, the et of environment specific applications may include biomedical, mobile, human machine interaction, industrial/manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

While the foregoing invention has been described in some detail for purposes of clarity and understanding, it will be appreciated by one skilled in the art, from a reading of the disclosure, that various changes in form and detail can be made without departing from the true scope of the invention.

1. A system for an event-based sensor readout, comprising:
a pixel die including a plurality of pixels receiving an analog signal;
a readout integrated circuit including a plurality of asynchronous dynamic vision sensors in operable communication with the plurality of pixels over a plurality of associated bitlines wherein the plurality of asynchronous dynamic vision sensors generate a plurality of event flag signals and a plurality of event data signals;
a column bus having a plurality of shift registers receiving the generated plurality of event flag and event data signals from the asynchronous dynamic vision sensors, wherein in the plurality shift registers serialize the generated plurality of event flag signals and event data signals;
a plurality of column lines transmitting the serialized plurality of event flag and event data signals to a data output.

2. The system for the event-based sensor readout of claim 1, wherein each of the plurality of pixels is a three transistor pixel and each of the plurality of the three transistor pixels includes a photodiode and a bitline output node.

3. The system for the event-based sensor readout of claim 1, wherein the plurality of event flag signals are representative of a detected change in pixel brightness.

4. The system for the event-based sensor readout of claim 3, wherein the plurality of event data signals are representative of a detected change in direction.

5. The system for the event-based sensor readout of claim 4, wherein the plurality of column lines includes a first column line and a second column line and the first column line receives the plurality of event flag signals and the second column line receives the plurality of event data signals.

6. The system for the event-based sensor readout of claim 1, further comprising:
a plurality of periphery circuits receiving the serialized plurality of event flag signals and event data signals.

7. The system for the event-based sensor readout of claim 1, wherein the plurality of shift registers perform a parallel in serial out operation with the generated plurality of event flag signals and event data signals from the asynchronous dynamic vision sensors.

8. A system for an event-based sensor readout, comprising:
a pixel die including a plurality of pixels receiving an analog signal;
a readout integrated circuit including a plurality of asynchronous dynamic vision sensors in operable communication with the plurality of pixels over a plurality of associated bitlines wherein the plurality of asynchronous dynamic vision sensors generate a plurality of event flag signals and event data signals;
a column bus receiving the generated plurality of event flag signals and event data signals from the asynchronous dynamic vision sensors;
a plurality of column lines transmitting the generated plurality of event flag signals and event data signals to a data output.

9. The system for the event-based sensor readout of claim 8, further comprising:
an electrical clamp line pre-charging the plurality of column lines to a predefined voltage level.

10. The system for the event-based sensor readout of claim 8, further comprising:
a global sampling block sampling the generated plurality of event flag signals and event data signals from the asynchronous dynamic vision sensors.

11. The system for the event-based sensor readout of claim 8, further comprising:
a row select logic block generating a switch enable signal utilized to control a plurality of switches.

12. A system for an event-based sensor readout, comprising:
a pixel die including a plurality of pixels receiving an analog signal;
a readout integrated circuit including a plurality of asynchronous dynamic vision sensors in operable communication with the plurality of pixels over a plurality of associated bitlines wherein the plurality of asynchronous dynamic vision sensors generate a plurality of event flag signals and event data signals;
a column bus receiving the generated event flag and event data signals from the asynchronous dynamic vision sensors;
a plurality of single-ended column bitlines transmitting the generated plurality of event flag signals and event data signals to a data output.

13. The system for the event-based sensor readout of claim 12, further comprising:
an electrical clamp line applying a clamp voltage at a plurality of input nodes associated with a plurality of sense amplifiers.

14. The system for the event-based sensor readout of claim 12, further comprising:
a global sampling block sampling the generated plurality of event flag signals and event data signals from the asynchronous dynamic vision sensors;
a row select logic block generating a switch enable signal utilized to control a plurality of switches.

15. A method for performing readout of an event-based sensor, comprising:
receiving an analog signal at a pixel die including a plurality of pixels;
connecting the pixel die with a readout integrated circuit, the readout integrated circuit including a plurality of asynchronous dynamic vision sensors in operable communication with the plurality of pixels over a plurality of associated bitlines wherein the plurality of asynchronous dynamic vision sensors;
generating, by plurality of asynchronous dynamic vision sensors, a plurality of event flag signals and event data signals;
receiving the generated plurality of event flag and event data signals at a column bus having a plurality of shift registers, wherein in the plurality shift registers serialize the generated plurality of event flag and event data signals;
transmitting, via a plurality of column lines, the serialized plurality of event flag signals and event data signals to a data output.

16. The method for performing readout of an event-based sensor of claim 15, further comprising:
representing a detected change in brightness within the generated plurality of event flag signals.

17. The method for performing readout of an event-based sensor of claim 15, further comprising:
representing a detected change in direction within the generated plurality of event data signals.

18. The method for performing readout of an event-based sensor of claim 15, further comprising:
performing a parallel in serial out operation with the generated plurality of event flag signals and event data signals from the asynchronous dynamic vision sensors.

19. The method for performing readout of an event-based sensor of claim 15, further comprising:
receiving the serialized plurality of event flag signals and event data signals at a plurality of periphery circuits.

20. The method for performing readout of an event-based sensor of claim 19, further comprising:
conducting a row status check at the beginning of a frame;
conducting an event registered check based on the generated plurality of event flag signals and event data signals from the asynchronous dynamic vision sensors;
reading the generated plurality of event flag signals and event data signals onto the plurality of column lines when the event registered check is positive;
storing the generated plurality of event flag signals and event data signals onto the plurality of periphery circuits.
